(19) United States
(12) Patent Application Publication
(10) Pub. No.: US 2019/0039103 A1
(43) Pub. Date: Feb. 7, 2019

(54) Popcorn Ceiling Eliminator

(71) Applicant: Robert M. Morris, SR., Allen, TX (US)

(72) Inventor: Robert M. Morris, SR., Allen, TX (US)

(21) Appl. No.: 16/052,443

(22) Filed: Aug. 1, 2018

Related U.S. Application Data
(60) Provisional application No. 62/539,567, filed on Aug. 1, 2017.

(51) Int. Cl. B08B 7/04; B08B 1/00; B08B 3/04; B08B 5/04; A47L 9/06

(52) U.S. Cl. CPC B08B 7/04; B08B 1/005; A47L 9/06; B08B 5/04; B08B 3/04

(57) ABSTRACT

A popcorn eliminator device used to remove the popcorn design from the ceilings is disclosed. A popcorn eliminator device for scraping and cleaning comprises a vacuum head, a main scraper blade, a front scraper blade, an adaptor, a plastic collection tube and a connection hose and a shop vacuum. The adaptor connects the plastic collection tube using a connection hose to a heavy-duty shop vacuum. The popcorn eliminator device is flipped over and applied to the ceiling using a pushing motion and the front scraper blade is pressed into the slot in the front lip of the vacuum head, thereby scraping near the wall at the end of each pass. The popcorn eliminator device simultaneously collects the debris in the vacuum head resulting in the intake of debris by the vacuum.

### BACKGROUND OF THE INVENTION

### A. Technical Field

The present invention is generally related to a device for removing material from interior surfaces and, more specifically, to such devices that are adapted to remove acoustic texture material from ceiling surfaces.

### B. Description of Related Art

Acoustical ceiling tiles provide aesthetic appeal, acoustical modification or dampening, accessibility to space above the ceiling plane, and allow simple installation and removal. The “popcorn” ceiling also known as “cottage cheese” or “stucco” ceiling is formally known as an “acoustic” ceiling. The acoustic ceiling texture has a standard application for ceilings during construction of mostly residential structures. The “popcorn” ceiling could be quickly sprayed on and it has the bright white appearance and ability to hide imperfections along with its acoustical qualities so that the acoustic ceiling was quickly adopted by most professional construction establishments as a perfect solution to finishing out residential ceilings and was even applied to some business and commercial construction.

Existing problem with the acoustic ceiling texture is asbestos fibers. Asbestos was banned in construction in the clean air act of 1978. The replacement for asbestos application, contain paper-based or Styrofoam products, are used despite being unpopular and common practice in residential construction.

Currently, when any house is planned for remodeling, the end user has to climb on a ladder, where he/she uses a wide putty knife to scrape the ‘popcorn’ off the ceiling. The objects or furniture in the room must be moved out of the room or covered with plastic sheets. Any air handling should be turned off to avoid coating the ducts with the particles or gypsum powder. The end user should wear dust masks and eye protection to prevent inhalation of any dust material. All surfaces must be cleaned after removal, which can be difficult, because the dust and particles can become slightly charged with static electricity and sticks to everything. Dampening the ceiling does keep the dust down but the moistened gypsum can be tracked all over the office or home, causing additional cleanup work.

Although any sort of ceiling could suffer damage from a variety of causes (bumps and scratches by moving objects, water leaks, and so forth), popcorn ceilings can be particularly challenging to repair. Over a period, the popcorn ceiling discolors and degrades, allowing small particles to continually fall from the ceiling requiring cleaning to be done regularly to keep the home or office presentable. Removing this coating is an arduous task, with the Styrofoam or cellulose particles retained in the gypsum having a chance to migrate all around the room as they are being removed.

The removal of an acoustic or “popcorn” ceiling is usually a difficult and messy process. Water is usually applied to dampen the material to reduce adhesion and dust. The dust may contain dangerous asbestos fibers, so the user must be cautious while removing the ceiling material. Usual methods might involve scraping the material off the ceiling after spraying the ceiling with water. This results in acoustic material from the ceiling falling everywhere in the room. Exposure to dust is minimized by the application of water but the result of mounds of ceiling material presents a problem for anyone with the unfortunate assignment of the clean-up of the waste debris from the acoustic ceiling removal. The two-step process of removal and clean-up is always inefficient, messy and time-consuming.

Therefore, there exists a need for a popcorn eliminator device to remove popcorn ceiling from any structure in an efficient and cost effective way.

### SUMMARY OF THE INVENTION

The present disclosure relates to a popcorn eliminator device for removing the popcorn ceiling texture using a vacuum head which simultaneously scrape the “popcorn” off the ceiling and remove the texture and debris using a heavy duty or smaller shop vacuum.

According to one preferred embodiment, a popcorn eliminator device is used to remove the popcorn design from the ceilings. A popcorn eliminator device for scraping and cleaning comprises a vacuum head, a main scraper blade, a front scraper blade and an adaptor. The adaptor connects a plastic collection tube using a connection hose to a heavy-duty shop vacuum. The popcorn eliminator device is flipped over and applied to the ceiling using a pushing motion so that the main scraper blade located on the contact side of the unit will scrape the “popcorn” texture off the ceiling. The front scraper blade is pressed into the slot in the front lip of the vacuum head and is used to remove the scraping near the wall at the end of each pass. The popcorn eliminator device simultaneously collects the debris in the vacuum head resulting in the intake of debris by the vacuum.

In a preferred embodiment, the vacuum head used for collection is connected to a shop vacuum using suitable adaptor. This vacuum head prevents the removed particles from falling onto the floor, being suspended in the room air, or settling on the adjacent walls. The vacuum head comprises a scraper blade made up of steel which presses against the ceiling to remove the dampened particulate and gypsum coating.

In an embodiment, a method of remodeling the ceiling includes the following steps: dampening the ceiling using a sprayer and tap water, connecting the vacuum head to the shop vacuum using an adaptor. A suction hose and a wand is part of the adaptor. The steps further include: pressing the front scraper blade of the vacuum head against the ceiling, and moving forward. The shop vacuum pulls any material removed by the main scraper blade into the vacuum head and transfers to the collection bin on the vacuum head, preventing any errant materials from being dropped onto the floor. The adaptor is made from material such as a rigid plastic suction tube so that the end user performs ceiling removal operation by standing on the floor in a simple and efficient manner.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a perspective view of end user using a popcorn ceiling eliminator device in accordance with one embodiment of the invention.

FIG. 2 shows a perspective view of a vacuum head of the popcorn ceiling eliminator device incorporating the aspects of the present invention.

FIG. 3 shows an adaptor connected to the vacuum head of the popcorn ceiling eliminator device incorporating the aspects of the present invention.

FIG. 4 shows the lower portion of a main scraper blade of the vacuum head in the popcorn ceiling eliminator device incorporating the aspects of the present invention.

FIG. 5 shows an exploded view of the main scraper blade of the vacuum head in the popcorn ceiling eliminator device incorporating the aspects of the present invention.

FIG. 6 is a side view of the vacuum head incorporating the aspects of the present invention.

FIG. 7 shows a bottom view of the main scraper blade of the vacuum head in the popcorn ceiling eliminator device respectively.

FIG. 8 is the side view of the vacuum head of the popcorn ceiling eliminator device incorporating the aspects of the present invention.

FIG. 9 is bottom view of a front scraper blade installed in the vacuum head in the popcorn ceiling eliminator.

### DETAILED DESCRIPTION OF EMBODIMENTS

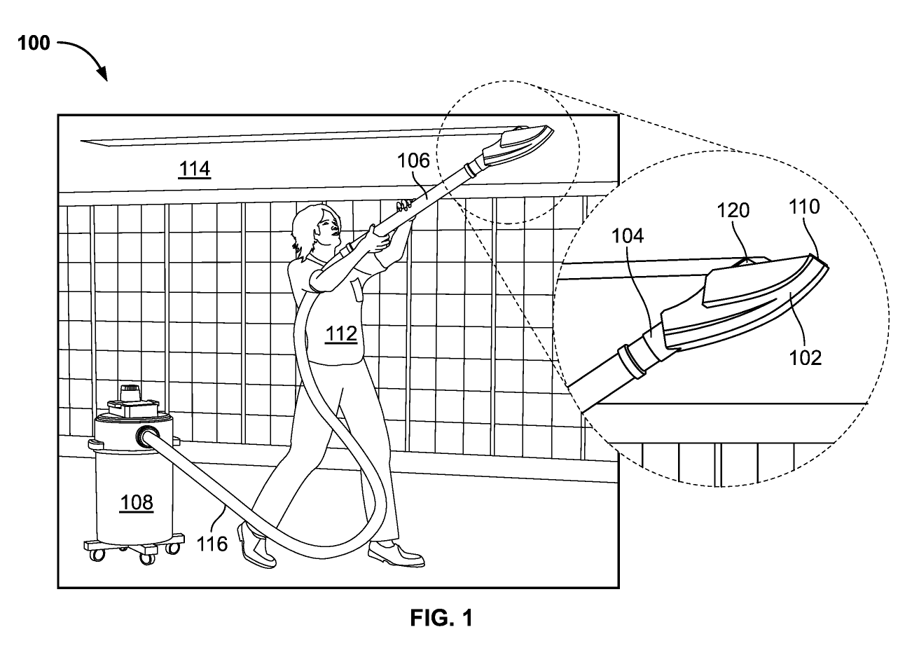

The present invention as shown in FIG. 1 relates to a popcorn eliminator device 100 used to remove the popcorn design from the ceilings 114. A popcorn eliminator device 100 for scraping and cleaning comprises a vacuum head 102, a main scraper blade 120, a front scraper blade 110, an adaptor 104, a plastic collection tube 106 and a connection hose 116 and a shop vacuum 108. The adaptor 104 connects the plastic collection tube 106 using a connection hose 116 to a heavy-duty shop vacuum 108. The end user 112 using the popcorn eliminator device 100 is flipped over and applied to the ceiling 114 using a pushing motion such that the main scraper blade 120 located on the contact side of the device 100 will scrap the “popcorn” texture off the ceiling 114. The front scraper blade 110 is pressed into the slot in the front lip of the vacuum head 102 and is used to remove the scraping near the wall at the end of each pass. The popcorn eliminator device 100 simultaneously collects the debris in the vacuum head 102 resulting in the intake of debris by the vacuum.

In a preferred embodiment, the vacuum head 102 is built by high-quality lightweight materials and could be used with the heavy duty or standard shop vacuum 108. The adaptor 104 is designed such that it could be used to fix with smaller standard size shop vacuum 108. The popcorn eliminator device 100 could also be connected to an industrial vacuum. The vacuum head 102 prevents the removed particles from falling onto the floor, being suspended in the room air, or settling on the adjacent walls. The front scraper blade 110 presses against the ceiling 114 to remove the dampened particulate and gypsum coating.

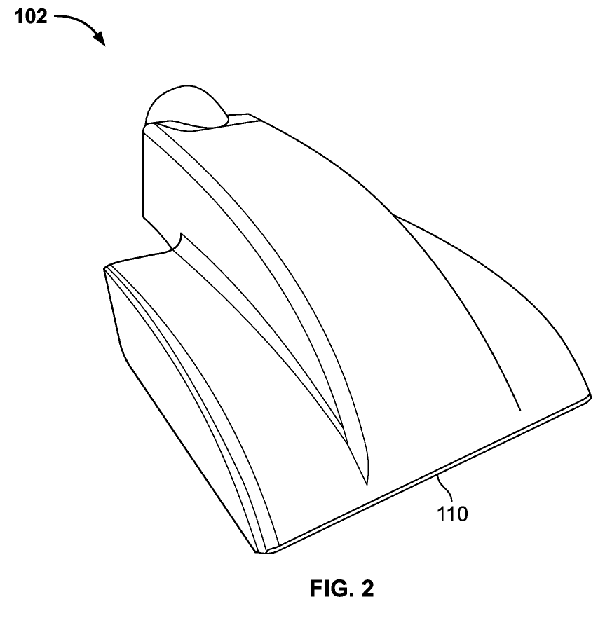

In an embodiment as shown in FIG. 2, the vacuum head 102 popcorn eliminator device is disclosed. The vacuum head 102 is injection molded using fiberglass reinforced polypropylene plastic. The plastic used in the vacuum head 102 is very durable, highly resistant to abrasive wear and drop shocks, highly resistant to household and industrial chemicals, and easy to clean using soap and water. The vacuum head 102 could be manufactured with any vibrant distinctive color to enhance the aesthetic appearance. The vacuum head 102 is designed to accept the main scraper blade 120, which is screwed into place using the supplied stainless steel mounting fasteners 118. The vacuum head 102 is sized to be about 2″ wider than the main scraper blade 120 to intercept any errant material that may flow off the edges of the scraper. The back of the vacuum head 102 has a 2.0″ internal diameter (2.5″ OD) hose fitting molded into the housing that connects to most high-volume shop vacuums 108. The vacuum head 102 is shipped with a molded adaptor 104 (2.5″ to 1.25″) that allow connection to almost all other vacuum hose sizes and also any other additional scraper blades such as main scraper blade 120 can be added. The shop vacuums 108 employ 2.5″ or 1.25″ diameter vacuum hoses and tubes.

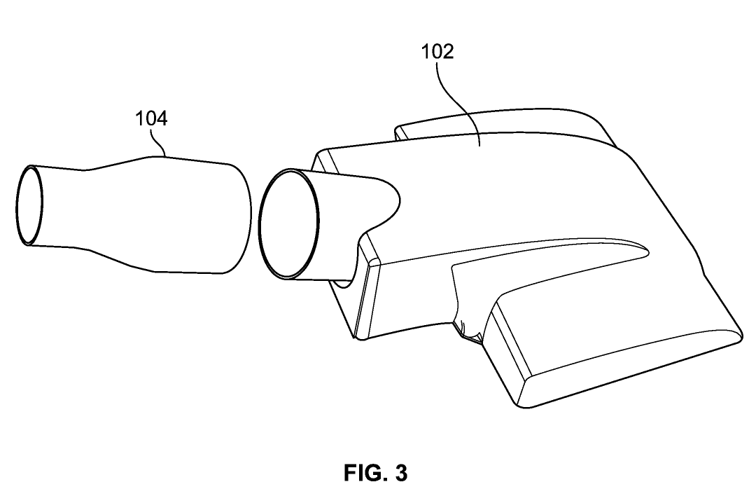

According to FIG. 3, the adaptor 104 connected to the vacuum head 102 of the popcorn ceiling eliminator device 100 incorporating the aspects of the present invention. Utilizing the adaptor 104, the popcorn ceiling eliminator 100 could be used with a heavy-duty shop vacuum 108 or a smaller vacuum. The adaptor 104 moves such debris into any suitable vacuum collector system such as for example, heavy duty or standard shop vacuum 108 as shown, FIG. 1, where the vacuum 108 is connected to the outlet end of connection hose 116.

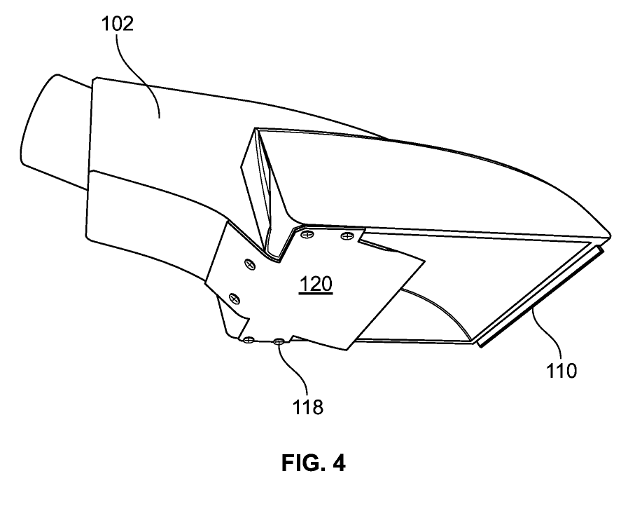

According to FIG. 4, the lower portion of the main scraper blade 120 of the vacuum head 102 in the popcorn ceiling eliminator device 100 incorporating the aspects of the present invention. The main scraper blade 120 is fabricated from 0.125″ thick, type 304 stainless steel sheets. Several sheets are stacked together and milled to shape using a CNC water jet machining station. After the outline and holes are developed in the thin sheet, the cut piece is robotically stamped to shape in a flywheel press and a specialty die. These blades are shaped to hold the capture head approximately 0.5″ away from the ceiling 114. Extra blades are stacked in two groups and shrinking wrapped together. The main scraper blade 120 is tough and retains the spring tension and scraping edge over a building use.

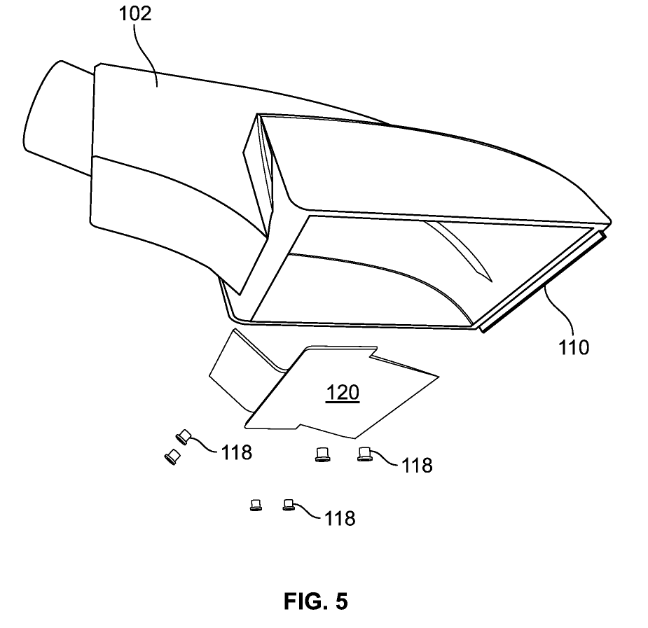

According to FIG. 5, the exploded view of the main scraper blade 120 of the vacuum head 102 in the popcorn ceiling eliminator device 100. The suction head in the popcorn ceiling eliminator device 100 is used to removes debris. The front scraper blade 110 is placed for close to wall and corners. The main scraper blade 120 and the front scraper blade 110 are made up of steel which removes debris quickly and easily. The main scraper blade 120 could be screwed up based on the requirement of ceiling 114. The scraper blade is screwed into the vacuum head 102 with the stainless-steel fasteners 118 and could be replaced any time when it becomes worn.

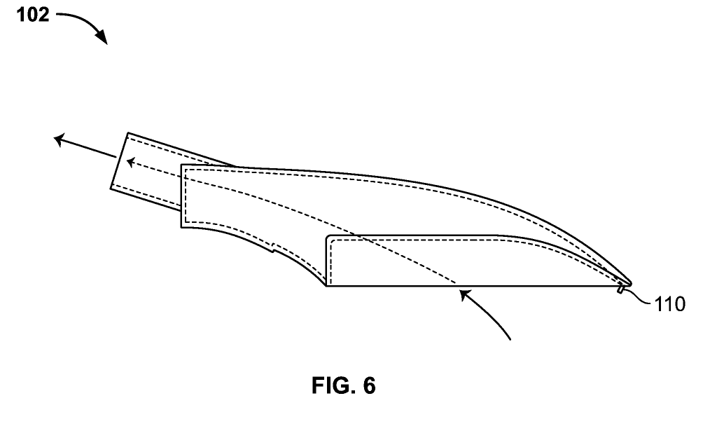

Referring to FIG. 6, a side view of the vacuum head 102 incorporating the aspects of the present invention. The lip of the vacuum head 102 is held approximately 0.50″ away from the ceiling surface 114 with the semi-flexible front scraper blade 110 riding against the ceiling 114 and the vacuum pulls the scraper loosened material into the vacuum head 102 without any loss of loosened ceiling material 114. The vacuum head 102 is about 1″ larger at the three edges of the scraper blade edges to collect all errant material. The shop vacuum 108 pulls the dampened ceiling 114 loosened by the scraper into the vacuum head 102 through the attached connecting hose 116, and cleanly ejects it into the vacuum base for later disposal. Sealed plenum provides a good flow of air around the main scraper blade 120 within the vacuum head 102 and directs the material smoothly to the vacuum connecting hose 116. The main scraper blade 120 is semi-flexible and extends about 0.50″ out of the vacuum head 102 and is pressed against the ceiling 114, insuring continuous contact with the sheetrock while the vacuum head 102 is held approximately 0.5″ away from it. The front scraper blade 110 near the front lip allows the end user 112 to remove the 2″ inch near the vertical wall by tipping the connection hose 116 away from the ceiling 114 and pulling the head back from the wall.

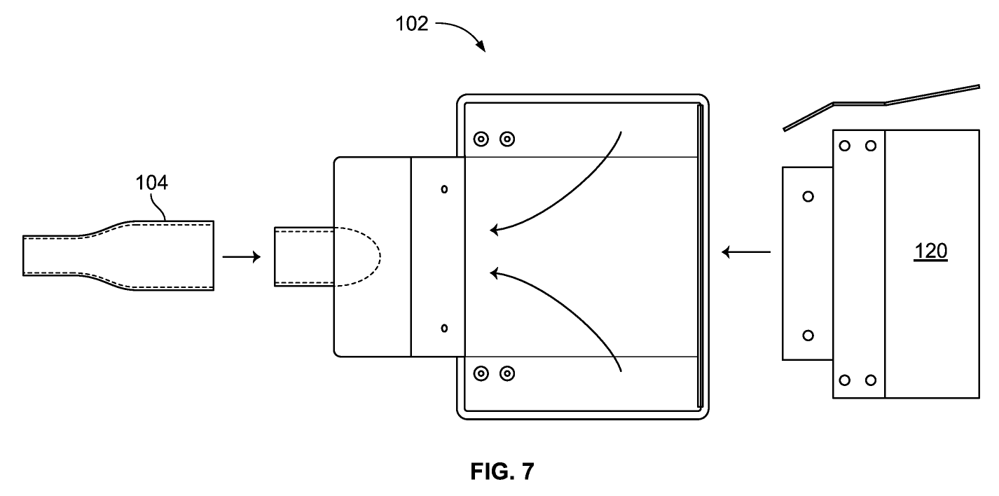

FIG. 7 shows a bottom of the main scraper blade 120 of the vacuum head 102 in the popcorn ceiling eliminator device 100. The vacuum pulled by the shop vacuum 108 pulls the air around the main scraper blade 120, into the plenum chamber, and then out through the cylindrical outlet on the rear of the suction head. The threaded standoffs allow the stainless-steel scraper to be changed when it becomes too worn to remove the ceiling 114 material effectively. The vacuum line adaptor 104 allows the end user 112 to use any size of shop vacuum 108 while employing the scraper head. Each device is equipped with an adaptor 104. The adaptor 104 is made up of molded fiberglass reinforced plastic which is very durable and easy to clean after or during use. The main scraper blade 120 is 0.125″ thick stainless steel sheet is formed in a die to provide the optimum shape for use. The material used for manufacturing the main scraper blade 120 is resistant and long lasting. The popcorn eliminator device is equipped with main scraper blade 120 and front scraper blade 110.

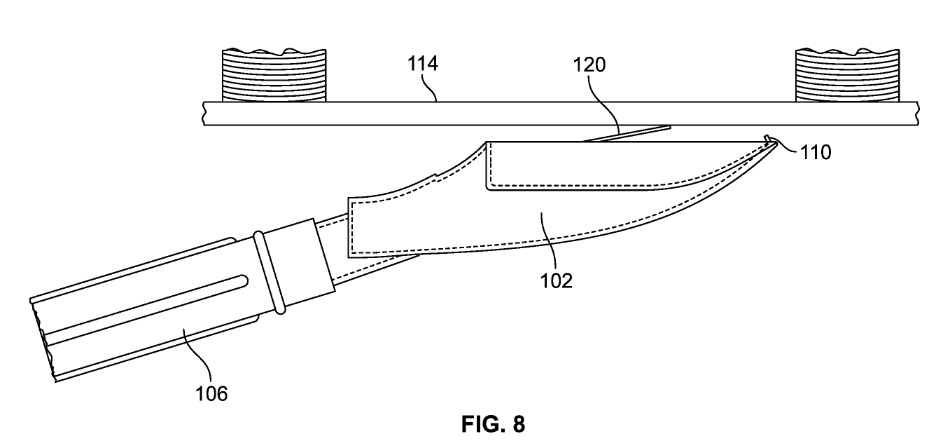

FIG. 8 is the side view of with main scraper blade 120 and front scarper blade 110 installed vacuum head 102 of the popcorn ceiling eliminator device 100 incorporating the aspects of the present invention. The 0.125″ thick stainless steel blade 120 is mounted on the bottom of the vacuum head 102, and is secured with stainless steel fasteners 118. The plastic collection tube 106 is pressed onto the vacuum head 102 outlet for transfer to the shop vacuum base 108. Ceiling 114 sheetrock upon which the popcorn ceiling coating is being removed. The vacuum head 102 does not touch the ceiling 114 allowing the removed material to drop into the vacuum head 102 and be ejected into the shop vacuum base 108.

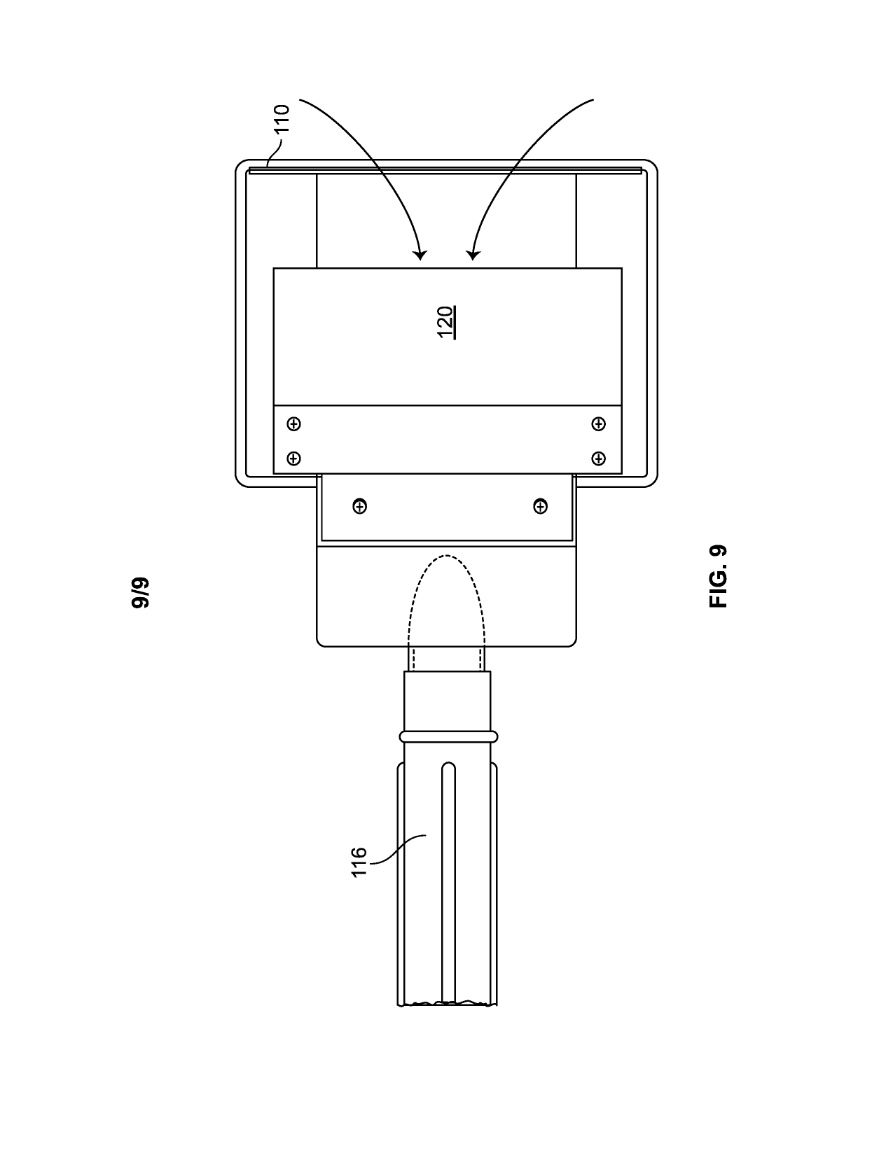

FIG. 9 is bottom view of front scraper blade 110 installed in the vacuum head 102 of the popcorn ceiling eliminator device 100 incorporating the aspects of the present invention. The vacuum head 102 efficiently removes any loose material from around the front scraper blade 110 and moves it into the collection system. The blade on the front lip 110 is easily rotated to touch the ceiling 114 and remove the dampened popcorn material near the vertical wall, allowing the optimum in popcorn removal.

In a preferred embodiment, a method of remodeling includes the step of dampens the ceiling 114 in the area to be removed using a sprayer and tap water. The steps further include connecting the vacuum head 102 to the shop vacuum 108 using an adaptor 104 such as, suction hose and wand. The steps further include: pressing the front steel scraper blade 110 of the vacuum head 102 against the ceiling 114, and moving forward. The shop vacuum 108 pulls any material removed by the main steel scraper blade 120 into the vacuum head 102 and transfers to the collection bin on the vacuum head 102, preventing any errant materials from being dropped onto the floor. The popcorn eliminator device 100 performs ceiling 114 removal operation by standing on the floor below in a simple and efficient manner.

The popcorn eliminator device 100 has the additional advantages such as the device removes “popcorn” and vacuums debris in one step. It reduces time spent removing “popcorn” ceilings 114. The installation is easy to fix and remove such that it improves the environment area by reducing the waste falling into the ground. The popcorn eliminator device 100 is light-weight in construction. The front scraper blade 110 is integrated into the popcorn eliminator device 100 and the main scraper blade 120 is removably attached. The design of the popcorn eliminator device 100 fits with all shop vacuum 108 using the suitable adaptor 104. The device reduces the efforts of the end user 112 for cleanup. The method of using the popcorn eliminator device is easy to clean the ceiling 114 and this is a cost effective method of remodeling. The blade and vacuum of the popcorn eliminator device are highly efficient. The high quality materials are used for constructing the popcorn eliminator device 100 which increases the product life. The popcorn ceiling eliminator 100 is designed to be aesthetic and effective in the application.

It will be appreciated that popcorn eliminator device and components that are constructed in accordance with the present disclosure may be provided in various configurations individually or in combinations. Any variety of suitable materials of construction, configurations, shapes and sizes for the components and methods of connecting the components and shipping the components may be utilized to meet the particular needs and requirements of an end user.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

1. (canceled)

2) A popcorn eliminator device for removing the popcorn ceiling texture from a ceiling, comprising:
a vacuum head to create a vacuum;
a scraper blade to scrape popcorn off the ceiling a vacuum device to remove the texture and debris; and
wherein the popcorn eliminator device simultaneously scrapes the popcorn off the ceiling and remove the texture and debris.

3) A popcorn eliminator device as in claim 2, wherein the scraper blade includes a main scraper blade, a front scraper blade and an adaptor.

4) A popcorn eliminator device as in claim 2, wherein the adaptor connects to a collection tube using a connection hose to connect to the vacuum head.

5) A popcorn eliminator device as in claim 3, wherein the popcorn eliminator device includes a front lip having a slot and wherein the front scraper blade is configured to be pressed into the slot in the front lip of the vacuum head to remove the scraping near the wall at the end of each pass.

6) A popcorn eliminator device as in claim 2, wherein the vacuum head is configured as a shop vacuum.

7) A method of remodeling the ceiling comprising the following steps:
dampening the ceiling using a sprayer and water;
connecting a vacuum head to a vacuum using an adaptor;
pressing a front scraper blade of the vacuum head against the ceiling; and
moving the front scraper blade forward.

8) A method of remodeling the ceiling as in claim 7, wherein the adaptor includes a suction hose and a wand.
